(19) United States
(12) Patent Application Publication
(10) Pub. No.: US 2010/0116020 A1
(43) Pub. Date: May 13, 2010

(54) WIDE-BAND ACCELEROMETER SELF-RECOGNISING ITS CALIBRATION

(75) Inventor: Massimiliano Titolo, Moncalieri (IT)

Correspondence Address: MAIER & MAIER, PLLC, 1000 DUKE STREET, ALEXANDRIA, VA, 22314, US

(73) Assignee: Sequoia IT S.R.L., Moncalieri (IT)

(21) Appl. No.: 12/598,108

(22) PCT Filed: Aug. 1, 2007
(86) PCT No.: PCT/IT07/00555

§ 371 Date: Oct. 29, 2009

(30) Foreign Application Priority Data
May 15, 2007 (IT) TO2007A000335

(51) Int. Cl. G01P 21/00

(52) U.S. Cl. 73/1.38

(57) ABSTRACT

A wide-band, single-axis or multiple-axis accelerometer or acceleration-measuring sensor, self-recognising its calibration is described, comprising at least one accelerometric detecting unit, such group being composed of at least two accelerometric transducers adapted to read, in a parallel way, different frequency bands, at least one electronic circuit for conditioning and digitising signals coming from the accelerometric detecting unit and at least one microprocessor adapted to read the signals through the conditioning and digitising electronic circuit and to recombine them for every measuring axis into at least one global output signal.

The present invention refers to a wide-band accelerometer self-recognising its calibration.

Numerous solutions are known in the art dealing with single-axis or multiple-axis accelerometers or acceleration measuring sensors, self-calibrated or able to be calibrated with automatic procedures, such as those disclosed, for example, in prior patents n. KR940008199, JP2006091013, WO02059627, U.S. Pat. No. 5,060,504, U.S. Pat. No. 3,120,622, US2007073502, KR20060056230, US2006059976, GB1246212, WO03065054, US2003061859, U.S. Pat. No. 6,640,609, U.S. Pat. No. 6,823,279, EP1227328, U.S. Pat. No. 6,035,694, JP11248743, U.S. Pat. No. 5,621,157, U.S. Pat. No. 5,445,006, CN87105637, U.S. Pat. No. 4,158,956, U.S. Pat. No. 3,470,730, U.S. Pat. No. 3,464,255, U.S. Pat. No. 3,241,355, U.S. Pat. No. 3,350,916.

These known sensors, however, allow reading only limited frequency bands.

Moreover, known, sensors either cannot be calibrated or, if such possibility is provided, it is the result of the adoption of extremely complex and costly technical arrangements.

Therefore, object of the present invention is solving the above prior art problems by providing a single-axis or multiple-axis accelerometer or acceleration-measuring sensor, that is able to detect a wide frequency spectrum.

Moreover, an object of the present invention is providing a single-axis or multiple-axis accelerometer or acceleration-measuring sensor, self-recognising its calibration, that is thereby able to autonomously, simply, quickly and economically verify it correct calibration.

The above and other objects and advantages of the invention, as will result from the following description, are obtained with a wide-band accelerometer self-recognising its calibration as described in claim 1. Preferred embodiments and non-trivial variations of the present invention are the subject matter of the dependent claims.

It will be immediately obvious that numerous variations and modifications (for example related to shape, sizes, arrangements and parts with equivalent functionality) can be made to the described device without departing from the scope of the invention as appear from the enclosed claims.

The present invention will be better described by some preferred embodiments thereof, provided as a non-limiting example, with reference to the enclosed drawings, in which:

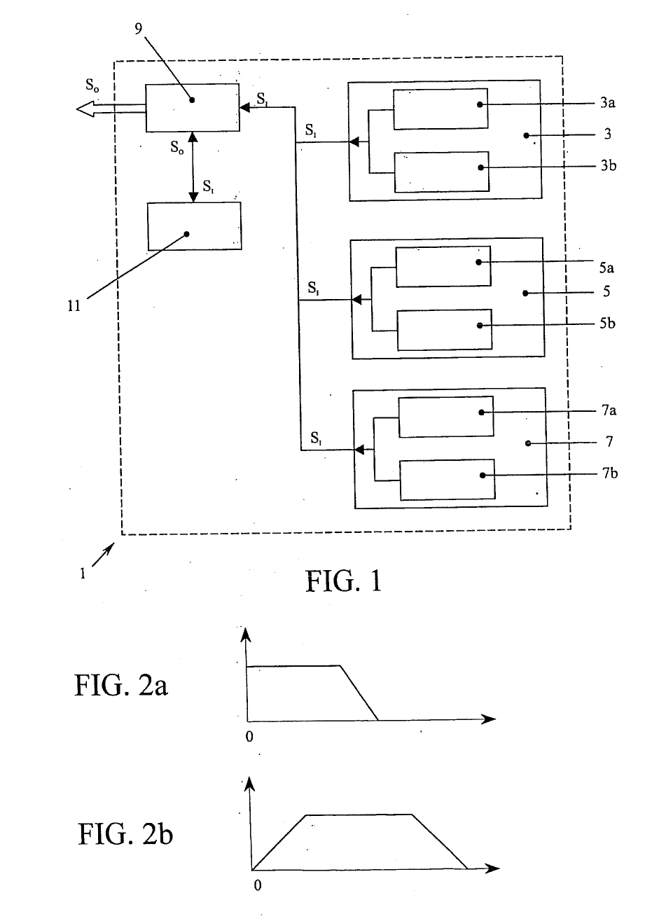

FIG. 1 shows a schematic diagram representing a preferred embodiment of the accelerometer according to the present invention; and

FIGS. 2a and 2b show two graphs representing a preferred detection mode of the accelerometer according to the present invention.

With particular reference to FIG. 1, it is possible to note that the wide band, single-axis or multiple-axis accelerometer or the acceleration-measuring sensor 1, self-recognising its calibration, comprises at least one accelerometric detecting unit, oriented according to at least one of the directions of the measuring axes of the accelerometer 1 itself, such unit being composed of at least two accelerometric transducers adapted to read, in a parallel way, different frequency bands. In particular, with reference to FIGS. 2a and 2b, it is possible to note that the reading mode of the two transducers included in each accelerometric detecting unit provides that at least the first one of the two (FIG. 2a) has a band that starts from the frequency with value zero or that is able, autonomously, to check its actual operation and guarantee the validity and its reading calibration performed in time, and that at least the second transducer (FIG. 2b) reads a frequency band that is partially overlapping the band read by the first transducer.

Obviously, in case of an accelerometer 1 of the single-axis type, a single accelerometric detecting unit, oriented along the measuring direction, will be enough. Instead, if the accelerometer 1 is of the multiple-axis type (such as for example the three-axes system shown in FIG. 1), three accelerometric detecting units, respectively 3, 5, 7, will be used, each one of which is oriented along one of the three measuring directions, such directions being preferably in agreement with a system of Cartesian axes X, Y and Z defined by the measuring system. Obviously, each accelerometric detecting unit 3, 5, 7 in turn will comprise a pair of transducers, respectively 3a and 3b, 5a and 5b, 7a and 7b, operating according to what has been described.

The accelerometer 1 according to the present invention further comprises at least one electronic circuit 9 for conditioning and digitising signals S_{I} coming from the accelerometric detecting units 3 and/or 5 and/or 7, and in particular from the respective pairs of transducers 3a and 3b and/or 5a and 5b and/or 7a and 7b, and for managing the output signals S_{O}. The accelerometer 1 according to the present invention further comprises at least one microprocessor 11 adapted, in particular, to read the digitised signals coming from each accelerometric detecting unit 3 and/or 5 and/or 7 through the conditioning and digitising electronic circuit 9 and to recombine them for every measuring axis in at least one global output signal S_{O}, transmitted in an analogue or digital way always through the conditioning and digitising electronic circuit 9, such output signal S_{O} being a wide-band signal that has as lower frequency the value zero (or, more generally, the lowest value of the band read by the first transducer) and as maximum value the maximum value of the accelerometer able to measure the frequency band with the highest value. The combination of the above elements, therefore, will allow, through the microprocessor 11, to combine the different acceleration readings and to rebuild a global signal of the acceleration measure with wide frequency spectrum that is able to be transferred outside in a digital or analogue way. The first transducer, moreover, will allow the microprocessor to verify its actual operation and calibration due to the technology of the transducer itself or indirectly by comparing the gravity acceleration with the reading of the value at zero frequency. Starting from this certified data, therefore, the microprocessor will be able, by exploiting the overlapping of the different frequency ranges, to validate the whole chain of transducers also with those transducers that are not technologically able to do this autonomously, thereby obtaining in real time a reading with wide frequency spectrum that is constantly verified. In particular, the accelerometer 1 according to the present invention will then be able to guarantee the perfect calibration of the whole chain of transducers, either starting from the guarantee provided by the first transducer or reading the acceleration value at a frequency with value zero and comparing it with the gravity acceleration along the measuring direction of the transducer or with the value, possibly computed by the same microprocessor 11, of the gravity acceleration vector module if the accelerometer 1 according to the present invention has no measuring direction aligned with the gravity acceleration direction. Once having validated the first transducer, the values read in the overlapping area between the first transducer and the immediately following transducer will be compared, thereby validating also the correct calibration of the second transducer. This procedure will then be repeated every time in case of systems with more than two transducers per accelerometric detecting unit.

Moreover, having suitably programmed the microprocessor 11, it is possible to allow the accelerometer 1 according to the present invention, if one of the transducers of the chain is not suitable calibrated, to:
automatically self-calibrate itself, where the technology of the employed transducers so allows;
communicate as output, through a suitable digital output (for example, of the electric, luminous, sound type) its actual incorrect calibration.

1. A wide-band, single-axis or multiple-axis accelerometer or acceleration-measuring sensor, the accelerometer or sensor being adapted to self-recognise its calibration, wherein the accelerometer or sensor comprises at least one accelerometric detecting unit, the unit being composed of at least two accelerometric transducers adapted to read, in a parallel way, different frequency bands, at least one electronic circuit for conditioning and digitising signals coming from the accelerometric detecting unit and at least one microprocessor adapted to read the signals through the conditioning and digitising circuit and to recombine them for every measuring axis into at least one global output signal.

2. The accelerometer of claim 1, wherein the accelerometric detecting unit is oriented according to at least one of the directions of the measuring axes.

3. The accelerometer of claim 1 wherein at least a first of the two transducers reads a frequency band that starts from a frequency with value zero and that at least a second of the two transducers reads a frequency band that is partially overlapped with the band read by said first transducer.

4. The accelerometer of claim 1, wherein the first transducer is autonomously able to check its actual operation and to guarantee a validity and its reading calibration performed in time.

5. The accelerometer of claim 1, wherein the accelerometer comprises three accelerometric detecting units, each one of which is oriented according to one of the three measuring directions, such directions being preferably in agreement with a system of Cartesian axes, each one of the accelerometric detecting units being respectively equipped with the two transducers.

6. The accelerometer of claim 1, wherein the output signal is a wideband signal whose frequency is equal to a lowest value of the band read by the first transducer and has as maximum value a maximum value of the transducer able to measure a frequency band with highest value.

7. The accelerometer of claim 3, wherein the first transducer cooperates with the microprocessor to verify its actual operation and calibration by comparing a gravity acceleration with the frequency reading with value zero.

8. The accelerometer of claim 3, wherein the first transducer is adapted to cooperate with the microprocessor to verify an actual operation and calibration of the transducer by comparing the reading with frequency with value zero with a value of a module of the gravity acceleration.
